(19) United States
(12) Patent Application Publication
(10) Pub. No.: US 2003/0195875 A1
(43) Pub. Date: Oct. 16, 2003

(54) Information management structure

(76) Inventors: Jeffrey W. Valk, Dallas, TX (US); Michael B. Davis, Dallas, TX (US)

Correspondence Address: SLATER & MATSIL, L.L.P., 17950 PRESTON RD, SUITE 1000, DALLAS, TX, 75252-5793, US

(21) Appl. No.: 10/396,539

(22) Filed: Mar. 25, 2003

Related U.S. Application Data
(60) Provisional application No. 60/367,178, filed on Mar. 25, 2002.
(60) Provisional application No. 60/403,327, filed on Aug. 13, 2002.

(51) Int. Cl. G06F 7/00; G06F 17/30

(52) U.S. Cl. 707/3

(57) ABSTRACT

An information management method includes a step of preparing an information management structure adapted to model business operations using data objects. The content for at least some of the objects relates to the operations. The preparing of the information management structure includes the following steps. A unique identifier is assigned to each object. An object composition, an object behavior, an object interrelationship (how that object relates to at least one other object), and an object interaction (how that object interacts with at least one other object) is defined for each object. The at least one other object is identified in a definition using its unique object identifier. An insight into a selected group of objects is defined based on the object composition definition, the object behavior definition, the object interrelationship definition, the object interaction definition, or any combination thereof, for each object in the selected group of objects.

This application claims the priority benefit of commonly owned U.S. Provisional Patent Application having Serial No. 60/367,178 entitled DATABASE SYSTEM FOR USE IN BUSINESS MANAGEMENT AND CORE ALGORITHMS AND ARCHITECTURE FOR THE DATABASE SYSTEM filed on Mar. 25, 2002, which is hereby incorporated by reference.

This application claims the priority benefit of commonly owned U.S. Provisional Patent Application having Serial No. 60/403,327 entitled CORE ALGORITHMS AND ARCHITECTURE FOR INFORMATION MANAGEMENT SYSTEM filed on Aug. 13, 2002, which is hereby incorporated by reference.

### CROSS-REFERENCE TO RELATED APPLICATION

This application is related to a commonly owned U.S. patent application having Ser. No. ______ entitled STATELESS CURSOR FOR INFORMATION MANAGEMENT SYSTEM filed on Mar. 25, 2003, having Attorney Docket Number MYR-004, and which is hereby incorporated by reference.

This application is related to a commonly owned U.S. patent application having Ser. No.______ entitled DYNAMIC THIN CLIENT FOR INFORMATION MANAGEMENT SYSTEM filed on Mar. 25, 2003, having Attorney Docket Number MYR-005, and which is hereby incorporated by reference.

This application is related to a commonly owned U.S. patent application having Ser. No.______ entitled SYSTEM ARCHITECTURE FOR INFORMATION MANAGEMENT SYSTEM filed on Mar. 25, 2003, having Attorney Docket Number MYR-006, and which is hereby incorporated by reference.

### TECHNICAL FIELD

The present invention generally relates to information management systems and software. In one aspect, it relates to an information management structure for modeling a business or operation using objects.

### BACKGROUND

There are many database systems and information management systems currently available. But most existing systems are not flexible and easily adaptable to different business models. Also, most of such systems are not well suited for being web-based applications that may be run over the Internet on a relatively small computer system (e.g., an older laptop computer or a hand-held computer device) and over a relatively slow connection (e.g., wireless, satellite, or modem connection). Making changes to or adapting most existing systems to a new business model or making changes for an evolving business model often requires a team of software developers, months of lead time, and thus lots of money. Such expense and lead time is often not feasible for a small business, and is undesirable to even the largest of companies that are looking for ways to save time and money on overhead resources.

It is becoming highly desirable for business applications to be capable of running on a web browser over the Internet for a number of reasons. With a web enabled business application, the user may have access to the Internet from virtually any location in the world. Also, a web enabled application may be continuously upgraded and improved without the need to redistribute new versions of the software on discs (e.g., magnetic media, optical media). Users typically prefer not to waste time and energy loading software on their computers every time the software is improved or every time existing bugs are fixed. However, one of the limiting factors for web enabled applications is the speed and bandwidth of a user's connection. For a user sitting in an office building connected to a high speed network connection, this is not such a problem. However, for users that travel or work in the field, their connection speeds are often quite limited. Hence, there is a need for a way to provide web based business applications that minimizes the amount of code and data passed down to the user, as well as limiting the amount of information sent up to the server from the user.

Another limiting factor for web enabled applications is the amount of memory available on the user's computer. Thus, it is desirable that any code, tables, and applications sent down to a user be compact and able to run on a wide variety of computers (i.e., older computers with limited RAM and processor speed, as well as newer computers with lots of RAM and high speed processors).

Therefore, there are two sides to the coin for a web based business application. There is a desire to minimize the use of server resources so that a given server may handle many more users with the same resources and so that the users' states are maintained. But this needs to be accomplished without overloading a user's resources and without the need to shuttle large amounts of information back and forth between the user and server. On the flip side of that coin, there is a desire to provide business applications to users over the web via a browser with lots of features and functionality, with access to lots of information, while tying together many remotely located users, and while maintaining the users' sessions and states. But this needs to be done without tying up server resources over long periods of time or for large sets of data. In other words, it is desirable to provide web-based applications without increasing the amount of resources needed at the server end nor at the user end, and users certainly do not want to wait for large amounts information to be shuffled between the server and the client. Hence, the challenge is to create a software solution that can perform complex tasks, can run quickly even in the most remote locations on low-bandwidth for smaller companies, yet remain robust enough to handle the myriad of complicated needs facing multi-billion dollar organizations.

### SUMMARY OF INVENTION

The problems and needs outlined above are addressed by embodiments of the present invention. In accordance with one aspect of the present invention, an information management method is provided. The information management method includes a step of preparing an information management structure adapted to model business operations using data objects. The content for at least some of the objects relates to the operations. The preparing of the information management structure includes the following steps, the order of which may vary. A unique identifier is assigned to each object. An object composition is defined for each object. An object behavior is defined for each object. An object interrelationship is defined for each object as to how that object relates to at least one other object, the at least one other object being identified using its unique object identifier. An object interaction is defined for each object as to how that object interacts with at least one other object, the at least one other object being identified using its unique object identifier. Then, an insight into a selected group of objects may be defined based on the object composition definition, the object behavior definition, the object interrelationship definition, the object interaction definition, or any combination thereof, for each object in the selected group of objects.

The objects may have an attribute or a property attribute included in its object composition definition. At least some of the objects each may have a required-information status and/or a validity definition included in its object behavior definition. At least some of the objects each may have a child-parent relationship and/or a sibling relationship with at least one other object specified in its object interrelationship definition, the at least one other child object being identified by its unique object identifier. At least some of the objects each may have a relationship link with at least one other object specified in its object interrelationship definition, where the at least one other object is identified by its unique object identifier. A defined insight may be presented to a user via a graphical user interface (e.g., web-based application running on a standard web browser). At least some of the objects each may have a specification in its object interaction definition as to how that object is used by at least one other object, where the at least one other object is identified using its unique object identifier. At least some of the objects each may have a specification in its object interaction definition as to how that object uses at least one other object, where the at least one other object is identified using its unique object identifier. At least some of the objects each may have a specification in its object interaction definition as to how that object is acted upon by at least one other object, where the at least one other object is identified using its unique object identifier. At least some of the objects each may have a specification in its object interaction definition as to how that object acts upon at least one other object, where the at least one other object is identified using its unique object identifier. At least some of the objects each may have a specification in its object interaction definition as to how that object is affected contingent upon a change to at least one other object, where the at least one other object is identified using its unique object identifier. At least some of the objects each may have a specification in its object interaction definition as to how a change to that object results in a change to at least one other object, where the at least one other object is identified using its unique object identifier. The object interaction definition may be based on the object interrelationship definition. The business operations may relate to drilling, well servicing, petroleum production, safety management, field consulting, or any combination thereof, for example.

In accordance with another aspect of the present invention, a computer system is provided, which includes a data repository, a server, and system software. The server is communicably coupled to the data repository. The system software resides in the computer system. The system software is adapted to run on the server and adapted to model business operations using data objects. The content for at least some of the objects relates to the operations. The system software is adapted to perform the following tasks, the order of which may vary. a unique identifier is assigned to each object. An object composition is defined for each object. An object behavior is defined for each object. An object interrelationship is defined for each object as to how that object relates to at least one other object, the at least one other object being identified using its unique object identifier. An object interaction is defined for each object as to how that object interacts with at least one other object, the at least one other object being identified using its unique object identifier. An insight into a selected group of objects then may be defined based the object composition definition, the object behavior definition, the object interrelationship definition, the object interaction definition, or any combination thereof, for each object in the selected group of objects.

### BRIEF DESCRIPTION OF THE DRAWINGS

The above features of the present invention will be more clearly understood from consideration of the following descriptions in connection with accompanying drawings in which:

FIG. 1 is a simplified schematic of a computer system of an embodiment of the present invention; and

FIG. 2 is a simplified schematic of a preferred process of the present invention.

### DETAILED DESCRIPTION OF PREFERRED EMBODIMENTS

Referring now to the drawings, wherein like reference numbers are used herein to designate like elements throughout the various views, preferred embodiments of the present invention are illustrated and described. One of ordinary skill in the art will appreciate the many applications and variations of the present invention in light of the following description of preferred embodiments of the present invention.

Because embodiments of the present invention generally relate to software for organizing and accessing information, as well as for business management through the effective use of the information, such embodiments may be applied to a myriad of fields. Essentially, any field, business, or operation where information and data regarding that field, business, or operation needs to be organized and easily accessed, or where such information may be useful in management of the operations, an embodiment of the present invention may be useful and highly desirable.

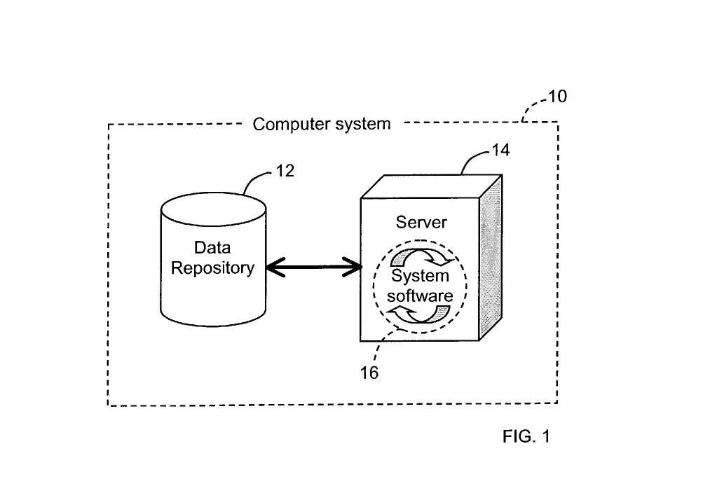

FIG. 1 is a simplified schematic of a computer system 10 of a preferred embodiment. The computer system 10 includes a data repository 12, a server 14, and system software 16. The data repository 12 is communicably coupled the server 14. The data repository 12 may be a single storage device, a single storage medium, a group of storage devices in a single location, a group of storage devices located in various geographical locations linked by a communication network, a legacy database system, or any combination thereof, for example. Likewise, the server 14 may be a single computer device having a processor, a single personal computer, a group of computer devices in a single location (each having at least a processor and random access memory), a group of computer devices located in various geographical locations linked by a communication network (each computer device having at least a processor and random access memory), or any combination thereof, for example. At least part of the server 14 may be at the same geographical location and/or within the same box or stack as at least part of the data repository 12. In another case, the server 14 may be geographically remote from the data repository 12 (e.g., communicably coupled via a communication network).

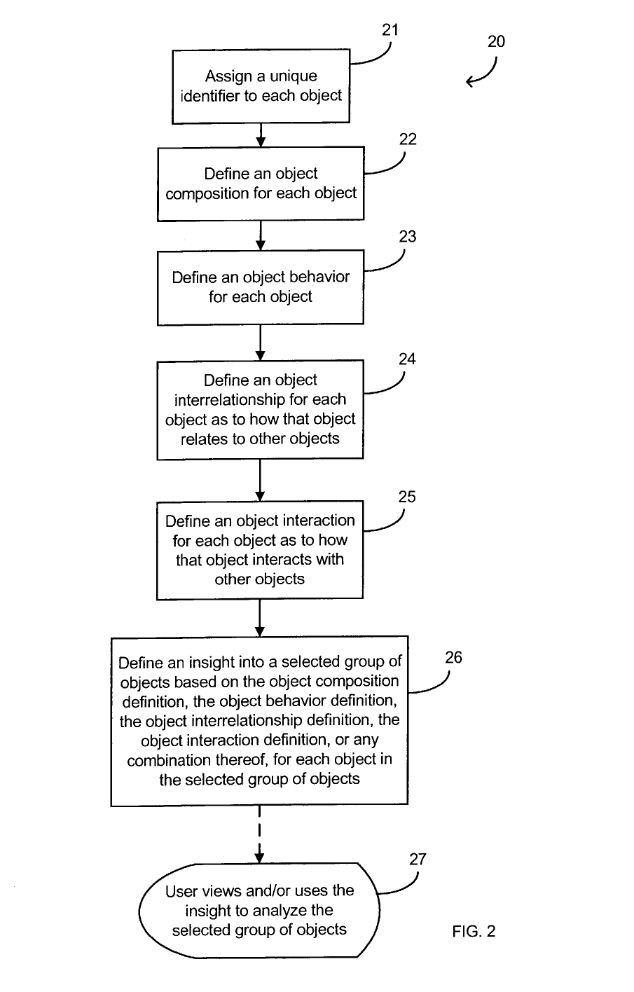

The system software 16 resides in the computer system 10 and is adapted to run on the server 14. The system software 16 is programmed to model business operations using data objects, e.g., using the preferred process 20 showing in FIG. 2.

FIG. 2 is a simplified schematic of a preferred process 20 of the present invention. The information management process 20 represented by FIG. 2 may be used to prepare an information management structure adapted to model business operations using data objects. In such model, the content for at least some of the objects relates to the operations being modeled. In preparing the information management structure, the following steps are preferably included. A unique identifier is assigned to each object (see block 21). In a preferred embodiment, the unique identifier is referred as an object identifier or OID.

An OID is preferably a 34 character string assigned to each object based on a globally unique identifier (GUID). A GUID is a 32 character string that is inherently unique. For purposes of this embodiment, two additional characters are tacked onto a GUID to create a property value called OID. A GUID is an algorithmically generated binary sequence that is guaranteed to be unique across time and space, no matter what machine you use to generate it, as long as the number GUIDs generated per second is less than a very large number (e.g., not greater than billions per second). Each object record in the database is assigned its own OID, and thus no two objects will ever have the same OID value. The OID is not a value that needs to be presented to the user, but is rather a way for the system to maintain data integrity and to have a unique identifier associated with each object/record. The OIDs are also used by the system to refer to other records, such as when setting up a table of association or relations among sets of objects. Thus, if there are twenty records having the same values for each property (except for the OID property), each record is still distinguishable based on its OID because each record has a globally unique identifier assigned to it. Therefore, no matter how many records are the same, as far as the user is concerned, each record has an OID value that ensures each record is unique. Preferably, the OID stays with the object forever until the object is deleted from the database.

An object composition is defined for each object (see block 22). An object composition includes the attributes and properties that make up the object. Some examples of object composition properties include (but are not limited to): a last name property, a first name property, a mobile phone number property, an office phone number property, an email address property, a description field, and/or a notes field, for example. For a given Job type, examples of object composition properties might include account name property, status property, date property, supervisor name property, and/or job description property, for example. For a given Safety Report type, examples of object composition properties might include date property, severity property, account property, and/or injured party property, for example. These are simply brief lists for a few examples. One of ordinary skill in the art will realize that the attributes and properties forming an object composition can relate to any piece of information or data associated with an actual business operation.

An object behavior is defined for each object (see block 23). An object behavior definition may set forth the minimum properties/attributes that are required for given object. For example, an object may be defined to be invalid if it does not include values for a first and last name property. An object behavior definition may set forth a required value range or character type for a given property/attribute value in order for the object to be valid or validated. Object behavior definitions may also be more complex, depending on the type of object. For example, an object behavior definition may be based upon a complex calculation or logic determination using values in other objects and/or using real-time data, constants, or constraints.

An object interrelationship for each object is defined as to how that object relates to other objects (see block 24). For example an object may have a parent-child and/or sibling relationship among one or more other objects. One specific example may be where a child object is a sub-category of a parent object, among other child objects. In such example, the multiple child objects may have sibling relationships defined amongst them.

An object interaction for each object is defined as to how that object interacts with other objects (see block 25). A simple example of an object interaction is where a rental price of a certain piece of equipment is calculated based on the person/entity renting it. Assuming each person/entity may have its own price list that has been negotiated, the rental price will require a lookup on that entity's price list for use in the calculation. The rental price may further depend upon the location of use for that rental period, as well as the rental period. Hence, there may be other price list look up tables for rental location and rental period that may factor into the rental price calculation. Hence, the rental price object being calculated may be related to and interacting with a price list for a particular entity, a rental location pricing list, and a rental period pricing list. Thus, by virtue of those three properties from three different objects, which may be two levels removed from each other for example, a software program may calculate the total rental price for an item according to a specified set of criteria.

Note that the order and sequence for the blocks 21, 22, 23, 24, and 25 in FIG. 2 may vary. For example, block 24 and 25 may be performed before block 23, and/or blocks 24 and 25 may be performed in parallel.

An insight into a selected group of objects is defined based on the object composition definition, the object behavior definition, the object interrelationship definition, the object interaction definition, or any combination thereof, for each group in the selected group of objects (see block 26). For example, if a user selects a particular account and wants to see all jobs for that account, an insight may be defined using the object interrelationships to identify and gather all jobs associated with that account. Hence, each job having the OID for that account linked to it to form an interrelation ship between them may be gathered using that account's OID.

If the user then selects a particular job and wants to see all the billings for that job, an insight may be defined to identify and gather all billing information associated with that job. Because the billing information may have parent-child relationships with various price lists and other criteria used to determine the billing totals, there may be several layers of abstraction to define that insight and provide that particular group of billing information (i.e., that selected group of objects). Hence, more complex insights are contemplated. The OIDs act as the references called upon by other objects for linking between various objects and for forming/defining interrelationships and interactions. Thus, a given object may reference numerous OIDs of other objects.

In essence, an insight definition is a particular perspective with which a user or another system looks into or looks at the information stored on a data repository. Insights may be developed and defined in real-time or on-the-fly in accordance to a user's request or another system's request. Block 27 shows one example use of an insight, among many different ways an insight may be used. A user may view and/or use the insight into the information on the data repository to analyze the selected group of objects.

By providing an organized structure to the information stored on the data repository, as described by the process 20 in FIG. 2 for example, the information may be managed more effectively to allow more insight into a business operation being modeled by the information management structure formed. Gathering and having mass amounts of information is usually not useful without an effective and efficient way to organize and provide insights into and correlations between those data. An embodiment of the present invention provides a way to organize and provide useful insights into data relating to a business operation or project. Such insights, correlations, and organization of the data relating to an operation or operations may allow managers, monitoring persons or systems, or other controllers to better track and manage such operations.

An embodiment of the present invention may be used to model many different types and kinds of businesses, operations, tasks, and/or records. The following describes just a few possible operations that an embodiment of the present invention may be used to model and to organize records relating thereto. As will be realized by one of ordinary skill in the art with the benefit of this disclosure, there are many more applications of the present invention.

An embodiment of the present invention may be used to organize and provide insights into data gathered from drilling operations. In the exploration and production of petroleum products, for example, the drilling industry currently records and gathers massive amounts of data and information at the job sites. Currently in the drilling industry there are about eight software packages from eight different companies used to aggregate daily drilling information at a well site while running on a client computer in the field. The current process for transferring information from the well site (where a drilling operation is being performed) back to a drilling company or its operator often involves the transfer of pdf files at the end of each 24 hour period, for example. A pdf file typically contains a daily well report and/or a daily tour sheet. Such information may then be transferred to the drilling company's customer(s).

As an example, operational data representing approximately 3,000 records and about 18,000 data points per job per day is a typical volume of data that may be provided using the current process. One problem with this current process is that an operator and/or driller usually cannot easily analyze such data to provide a statistical measure, which might be used to change or improve operations. Hence, most of such data is often never utilized.

Also, the current method of transferring administrative data (e.g., employee hours worked, as needed for drilling company's back-office accounting/human resources systems) and/or operational data (e.g., well bore data desired by operator's DIMS or WellView electronic well file) is typically performed indirectly. That is, clerks manually transfer data from pdf files into an appropriate system format. Yet, it would be much more preferably, reliable, and efficient to have a direct or automatic transfer of the data into a structure that will allow the data to be easily analyzed from different perspectives. Thus, applying a process of the present invention to develop an information management structure for the data would likely provide a desirable solution to this problem.

As an example, electronic data recorders and infrastructure may be placed on over 900 drilling rigs throughout North America to aggregate data from well sites and upload it to a database at least twice daily to generate reports. Using an embodiment of the present invention, a system-to-system import of the data may be performed and the data then may be put through at least part of the process 20 of FIG. 2 (discussed above) to assign OIDs and define object characteristics. Then, the data may be rendered using a web-based user interface, for example, to designated users (e.g., drilling companies, operating companies, and/or customers). Using insights into the data, such users may then query the data at will, analyze the data, and/or create management reports, for example. Also, because the data has been assigned OIDs and given object characterizations, relevant portions of the data may be programmatically extracted and exported into an appropriate internal system (e.g., for accounting, payroll, and human resources needs).

Preferably, operations data from multiple companies and multiple software platforms may be integrated for use together by running the data through at least part of the process 20 of FIG. 2. Even though the data may be collected from multiple companies using multiple software platforms, the drilling company or operators typically own the data that these companies collect for them. Hence, it would be preferable to use an embodiment of the present invention to integrate these data from multiple sources so that the drilling company, operators, and/or its customers may use all of the data together to provide an integrated insight into the operations.

Drilling information currently tracked on paper and broken down into subcategories per IADC (International Association of Drilling Contractors) activity codes may be tracked within a system incorporating an embodiment of the present invention to more readily and efficiently administer day to day operations. For example, activity code 8 (Rig Repair) for a given job(s) can be readily accessed and analyzed more efficiently than current processes of manually calculating said data currently aggregated on paper.

Based on this drilling operations example, it should be clear to see that an embodiment of the present invention may be applied to virtually any operation where the collection of information and data is performed. Just a few other example operations where an embodiment of the present invention may be applied include (but are not limited to): well servicing, field consulting, petroleum production, safety records for a business or operation, electronic data aggregated at the jobsite, and engineering applications, for example.

For example, an oil well services company may need to keep track of numerous pieces of equipment being used at numerous sites by a variety of employees and/or contractors. Also, the billing, progress statuses, deadlines, safety records, and worker training statuses, for example, are just some of the information of interest in managing such a company. To best use the information, the information needs to be organized and easily accessible. The information may be run through the system software using at least part of the process 20 of FIG. 2. Then, relevant information may be input and stored at a centralized data repository, which may be edited and accessed easily via a web-based application from virtually any remote location in the world (e.g., anywhere Internet access may be obtained).

It will be appreciated by those skilled in the art having the benefit of this disclosure that an embodiment of the present invention provides improved ways to manage, access, and/or analyze data. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. An information management method comprising:
preparing an information management structure adapted to model business operations using data objects, wherein content for at least some of the objects relates to the operations, the preparing of the information management structure comprising:
assigning a unique identifier to each object;
defining an object composition for each object;
defining an object behavior for each object;
defining an object interrelationship for each object as to how that object relates to at least one other object, the at least one other object being identified using its unique object identifier;
defining an object interaction for each object as to how that object interacts with at least one other object, the at least one other object being identified using its unique object identifier; and
defining an insight into a selected group of objects based on at least one of the object composition definition, the object behavior definition, the object interrelationship definition, and the object interaction definition for each object in the selected group of objects.

2. The method of claim 1, wherein each of the objects has an attribute included in its object composition definition.

3. The method of claim 1, wherein at least some of the objects each has a property attribute included in its object composition definition.

4. The method of claim 1, wherein at least some of the objects each has a required-information status included in its object behavior definition.

5. The method of claim 1, wherein at least some of the objects each has a validity definition included in its object behavior definition.

6. The method of claim 1, wherein at least some of the objects each has a child-parent relationship with at least one other object specified in its object interrelationship definition, the at least one other child object being identified by its unique object identifier.

7. The method of claim 1, wherein at least some of the objects each has a sibling relationship with at least one other object specified in its object interrelationship definition, the at least one other sibling object being identified by its unique object identifier.

8. The method of claim 1, wherein at least some of the objects each has a relationship link with at least one other object specified in its object interrelationship definition, the at least one other object being identified by its unique object identifier.

9. The method of claim 1, further comprising:
presenting the defined insight to a user via a graphical user interface.

10. The method of claim 1, wherein at least some of the objects each has a specification in its object interaction definition as to how that object is used by at least one other object, the at least one other object being identified using its unique object identifier.

11. The method of claim 1, wherein at least some of the objects each has a specification in its object interaction definition as to how that object uses at least one other object, the at least one other object being identified using its unique object identifier.

12. The method of claim 1, wherein at least some of the objects each has a specification in its object interaction definition as to how that object is acted upon by at least one other object, the at least one other object being identified using its unique object identifier.

13. The method of claim 1, wherein at least some of the objects each has a specification in its object interaction definition as to how that object acts upon at least one other object, the at least one other object being identified using its unique object identifier.

14. The method of claim 1, wherein at least some of the objects each has a specification in its object interaction definition as to how that object is affected contingent upon a change to at least one other object, the at least one other object being identified using its unique object identifier.

15. The method of claim 1, wherein at least some of the objects each has a specification in its object interaction definition as to how a change to that object results in a change to at least one other object, the at least one other object being identified using its unique object identifier.

16. The method of claim 1, wherein the object interaction definition is based on the object interrelationship definition.

17. The method of claim 1, wherein the business operations relate to drilling.

18. The method of claim 1, wherein the business operations relate to well servicing.

19. The method of claim 1, wherein the business operations relate to petroleum production.

20. The method of claim 1, wherein the business operations relate to safety management.

21. The method of claim 1, wherein the business operations relate to field consulting.

22. A computer system comprising:
a data repository;
a server communicably coupled to the data repository; and
system software residing in the computer system, the system software being adapted to run on the server and adapted to model business operations using data objects, wherein content for at least some of the objects relates to the operations, the system software being adapted to:
assign a unique identifier to each object,
define an object composition for each object,
define an object behavior for each object,
define an object interrelationship for each object as to how that object relates to at least one other object, the at least one other object being identified using its unique object identifier,
define an object interaction for each object as to how that object interacts with at least one other object, the at least one other object being identified using its unique object identifier, and
define an insight into a selected group of objects based on at least one of the object composition definition, the object behavior definition, the object interrelationship definition, and the object interaction definition for each object in the selected group of objects.

23. The computer system of claim 22, wherein each of the objects has an attribute included in its object composition definition.

24. The computer system of claim 22, wherein at least some of the objects each has a property attribute included in its object composition definition.

25. The computer system of claim 22, wherein at least some of the objects each has a required-information status included in its object behavior definition.

26. The computer system of claim 22, wherein at least some of the objects each has a validity definition included in its object behavior definition.

27. The computer system of claim 22, wherein at least some of the objects each has a child-parent relationship with at least one other object specified in its object interrelationship definition, the at least one other child object being identified by its unique object identifier.

28. The computer system of claim 22, wherein at least some of the objects each has a sibling relationship with at least one other object specified in its object interrelationship definition, the at least one other sibling object being identified by its unique object identifier.

29. The computer system of claim 22, wherein at least some of the objects each has a relationship link with at least one other object specified in its object interrelationship definition, the at least one other object being identified by its unique object identifier.

30. The computer system of claim 22, further comprising:
presenting the defined insight to a user via a graphical user interface.

31. The computer system of claim 22, wherein at least some of the objects each has a specification in its object interaction definition as to how that object is used by at least one other object, the at least one other object being identified using its unique object identifier.

32. The computer system of claim 22, wherein at least some of the objects each has a specification in its object interaction definition as to how that object uses at least one other object, the at least one other object being identified using its unique object identifier.

33. The computer system of claim 22, wherein at least some of the objects each has a specification in its object interaction definition as to how that object is acted upon by at least one other object, the at least one other object being identified using its unique object identifier.

34. The computer system of claim 22, wherein at least some of the objects each has a specification in its object interaction definition as to how that object acts upon at least one other object, the at least one other object being identified using its unique object identifier.

35. The computer system of claim 22, wherein at least some of the objects each has a specification in its object interaction definition as to how that object is affected contingent upon a change to at least one other object, the at least one other object being identified using its unique object identifier.

36. The computer system of claim 22, wherein at least some of the objects each has a specification in its object interaction definition as to how a change to that object results in a change to at least one other object, the at least one other object being identified using its unique object identifier.

37. The computer system of claim 22, wherein the object interaction definition is based on the object interrelationship definition.
